(19) United States
(12) Patent Application Publication
(10) Pub. No.: US 2012/0013455 A1
(43) Pub. Date: Jan. 19, 2012

(54) SYSTEM FOR DETERMINING A VIBRATION DOSAGE

(76) Inventor: Christian Von Holst, HETTENLEIDELHEIM (DE)

(21) Appl. No.: 13/164,074

(22) Filed: Jun. 20, 2011

(30) Foreign Application Priority Data
Jul. 16, 2010 (DE) 10 2010 031 455.2

(51) Int. Cl. B60Q 1/00; G01P 15/00; G01H 11/00

(52) U.S. Cl. 340/438; 73/649; 73/514.01

(57) ABSTRACT

A system determines a vehicle vibration dosage. The system includes a movably mounted vehicle component, a sensor for sensing movement magnitude of the vehicle component and an evaluation unit. The evaluation unit calculates the dosage magnitude reflecting the vibration dosage, on the basis of the sensed movement magnitude. The evaluation unit stores the calculated dosage magnitude in a storage unit in the form of an appropriate dosage entry.

### FIELD OF THE INVENTION

The present invention relates to a system for determining a vibration dosage of a vehicle.

### BACKGROUND OF THE INVENTION

The drivers of commercial farm vehicles are exposed to considerable vibration stresses when carrying out field and transporting work. These stresses are transferred in the form of whole body vibrations, via the driver's seat, which is supported so it can move. Occupationally caused long-term vibration exposure can endanger the safety and health of the driver and cause undesired back problems.

European Guideline 2002/44/EC stipulates, in this respect, binding minimum standards for the admissible vibration dosage for drivers of farm commercial vehicles, working as employees, hired, for example, by a service supply agency. In this connection, reference is made, in particular, to the Publication of the International Organization for Standardization “ISO 2631 1, Mechanical Vibration and Shock—Evaluation of Human Exposure to Whole-body Vibration, Part 1: General Requirements, Second Edition 1997-05-01,” in which one can find, among other things, a suitable procedure for determining the vibration exposure and thus the vibration dosage.

### SUMMARY

Accordingly, an object of this invention is to provide a system for determining vibration dosage with which the driver his/her employer can check the current vibration dosage and its maintenance in conformity with guideline.

This and other objects are achieved by the present invention, wherein a system for determining a vibration dosage is provided. The system includes a vehicle component, which is movaby supported, a sensor for recording a movement magnitude of a movement of the vehicle component, and an evaluation unit. The evaluation unit calculates a dosage magnitude that reflects the vibration magnitude on the basis of the recorded movement magnitude. The evaluation unit transmits the calculated dosage magnitude to a storage unit, wherein the dosage magnitude is filed in the storage unit in the form of an appropriate dosage entry.

Since the vibration dosage increases with the time and intensity of the vibration exposure, the dosage entry filed in the storage unit is updated by the evaluation unit at regular time intervals by a recalculation of the dosage magnitude. The current vibration magnitude and its maintenance, in conformity with the guideline, can be checked, at any time, by a reading of the storage unit by the driver himself or by his employer.

The movable vehicle component is typically a driver's seat, mounted in a vibration-dampened manner, relative to a rigid vehicle frame, by means of appropriate spring elements. In addition, or alternatively, however, movement of an impact-dampened, suspended driver's cabin may be sensed by a sensor.

Preferably, the dosage entry comprises a daily vibration dosage, standardized to a pre-specified daily work time, and/or a time stamp, correlated with the daily vibration dosage. If a specified admissible daily vibration dosage is exceeded, then suitable measures are taken to reduce the vibration exposure of the driver—for example, in that work with lower vibration stress is assigned to him. If another daily vibration dosage, which is higher in comparison, is exceeded, then a continuation of the work is suspended at least until the next day. The time stamp can comprise, in particular, a date indication, which makes possible an evaluation of the time course of the daily exposure over a longer period of time also. The dosage entry can subsequently be read out from the storage unit and for the purpose of the evaluation, can be transmitted to a table calculation program. In this way, it can be easier for a doctor to reconstruct health complaints which appear time-delayed, which may be attributable to an inadmissible vibration exposure which goes back in time.

Furthermore, the storage unit may communicate with the evaluation unit, via a reversible interface, to produce a detachable data exchange connection.

In the simplest case, the reversible interface is an electrical plug connection. This permits the removal of the storage unit from the system, in accordance with the invention, and a replacement with another storage unit. In other words, it is possible to assign to each driver his own storage unit for the recording and monitoring of his individual vibration dosage.

In addition, or alternatively, the reversible interface can be a wireless data transmission path—for example, as a Bluetooth or infrared interface. In this case, the storage unit can be kept in a mobile terminal, carried by the driver, in particular, a mobile telephone, a handheld computer; a laptop, or the like. The setup of the data exchange connection takes place either automatically, as soon as the mobile terminal is in the reception area of the wireless data transmission path, or by initialization by the driver.

The storage unit can be a durable and robust semiconductor storage unit, for example, a rewritable storage card in the form of a flash storage unit. Among others, such flash storage units are known as a Multimedia Card (MMC), Secure Digital Memory Card (SD), or Memory Stick (MS), wherein the latter can be connected with the evaluation unit via a Universal Serial Bus (USB).

In order to be able to assign the storage card to a specific driver, it can be equipped with a suitable identification feature. The identification feature is, in particular, a PIN code, to be entered before driving begins, via a control panel or keypad.

Furthermore, it is possible for the evaluation unit to be connected with a display for displaying the calculated dosage magnitude. The display can be a vehicle-affixed display with wireless transmission via the reversible interface to the mobile terminal, equipped with a corresponding display. The display is preferably a graphics-capable display unit, which permits, in addition to a numerical display of the vibration dosage, the portrayal of its criticality, graphically in the form of corresponding diagram representations. This ensures that the drive always retains, during his work, an overview of the current vibration dosage. In addition, or alternatively, a wireless transmission of the dosage magnitude to be visualized is also imaginable via a GSM or UMTS network to a control center.

To notify the driver of reaching a critical vibration dosage, the evaluation unit may give out an acoustic and/or optical warning signal when the calculated dosage magnitude is greater than a threshold value specified for the daily exposure to be maintained. The optical warning signals can be easily understandable pictogram-like and/or variously colored graphic warning representations, preferably by means of the vehicle-affixed display, which is connected with the evaluation unit or correlated with the mobile terminal, and/or a separate optical signal transmitter, for example, an LED or OLED display.

In addition to, or alternatively, a vehicle-affixed signal transmitter can generate acoustic warning signals, or one correlated with the mobile terminal.

The movement magnitude is, in particular, an acceleration magnitude, recorded by the sensor, wherein the acceleration magnitude reflects a movable vehicle component, in acceleration appearing in at least one movement direction. Preferably, the sensor comprises several acceleration transmitters, which record acceleration components in an x, y, and z direction of the vehicle component. The movement magnitude recorded in such a way is subsequently transmitted to the evaluation unit, via a CAN data bus, located in the vehicle, or a comparable data bus.

The characteristic frequency spectrum and the direction of the acceleration components appearing on the movable vehicle component has considerable influence on the health, the perception of comfort, and the fatigue behavior of the driver. In this respect, it is advantageous if the evaluation unit for the calculation of the dosage magnitude carries out a filtering of the characteristic frequency spectrum of the recorded movement magnitude in the sense of a weighting of physiologically relevant frequency ranges.

### BRIEF DESCRIPTION OF THE DRAWINGS

FIG. 1 is a schematic diagram of a first embodiment of a vibration dosage determining system according to the invention;

FIG. 2 is a diagram showing an example of a course of the direction-dependent weighting functions Wᵢ, for determining the vibration dosage; and

FIG. 3 is a schematic diagram of a second embodiment of the invention.

### DESCRIPTION OF THE PREFERRED EMBODIMENT

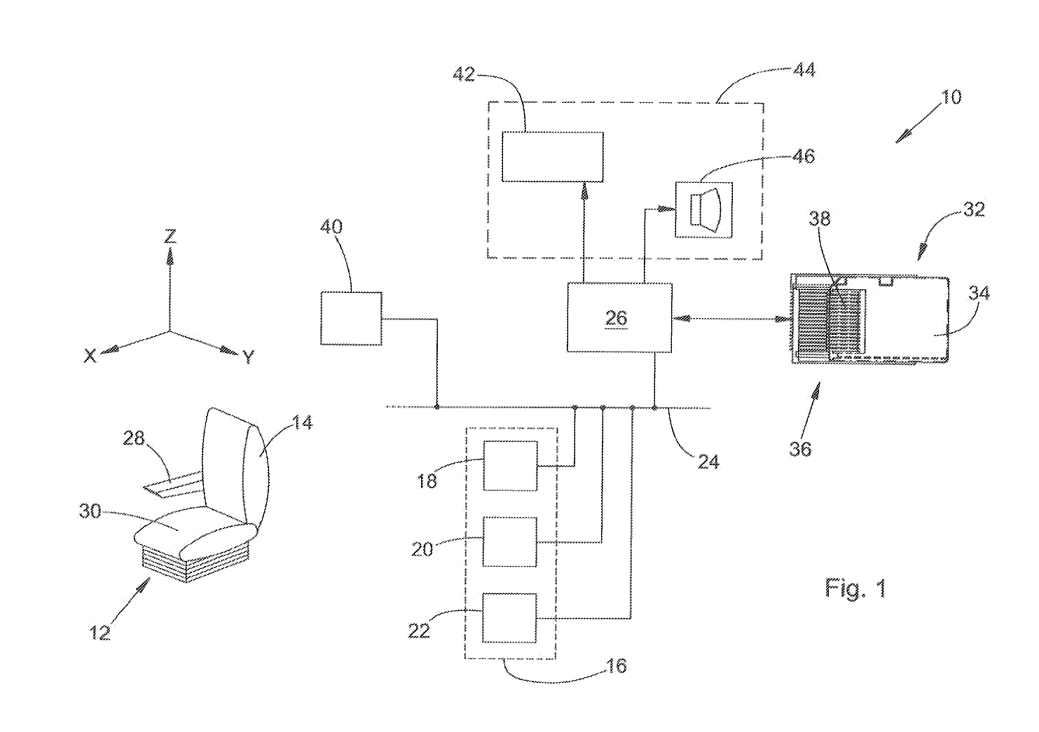

Referring to FIG. 1, a system 10 for determining a vibration dosage includes a vehicle component 12, such as a driver's seat 14, which is supported in a movable manner in a farm commercial vehicle. The driver's seat 14 is affixed in a vibration-dampened manner, relative to a rigid vehicle frame, by appropriate spring elements. A sensor 16 records a movement magnitude reflecting a movement of the driver's seat 14.

For example, the movement magnitude is an acceleration magnitude recorded by the sensor 16, wherein the acceleration device senses an acceleration of the driver's seat 14 in at least one movement direction. Stated more exactly, the sensor 16 comprises several acceleration transmitters 18, 20, and 22, which record acceleration components aₓ, a_{y}, a_{z}, in an x, y, and z direction of the driver's seat 14. The acceleration magnitude recorded in such a manner is transmitted to an evaluation unit 26, via a CAN data bus 24, located in the vehicle.

The evaluation unit 26 calculates a dosage magnitude reflecting the vibration dosage, on the basis of the acceleration magnitude. In the sense of short transmission paths, the sensor 16 is affixed on the driver's seat 14 in the immediate vicinity of the CAN data bus 24—in this case, in the area of an armrest, designed as a control console.

Since the vibration exposure of the driver primarily takes place via the seat area 30 of the driver's seat 14, the evaluation unit 26 for the calculation of the dosage magnitude first carries out a corresponding transformation of the acceleration components aₓ, a_{y}, a_{z}, recorded by means of the sensor 16. To this end, the evaluation unit 26 lays as a basis a transmission function of the form a′ᵢ=T*aᵢ (i=x, y, z). In the transmission function, aᵢ denotes the acceleration component, sensed in the area of the armrest 28; a′ᵢ, the acceleration component, transformed at the site of the seating area 30; and T, a transformation matrix, determined empirically for the individual driver's seat 14.

It should be noted at this point that the depicted arrangement of the sensor 16, in the area of the armrest 28, is merely an example. Thus, the sensor 16 can also be directly correlated with the seat area 30 or any other part of the driver's seat 14, for example, a back, comprised by it. Which of the aforementioned possibilities is, in the end, selected, depends on the technical circumstances in the individual case and not least, on the possible construction space limitations.

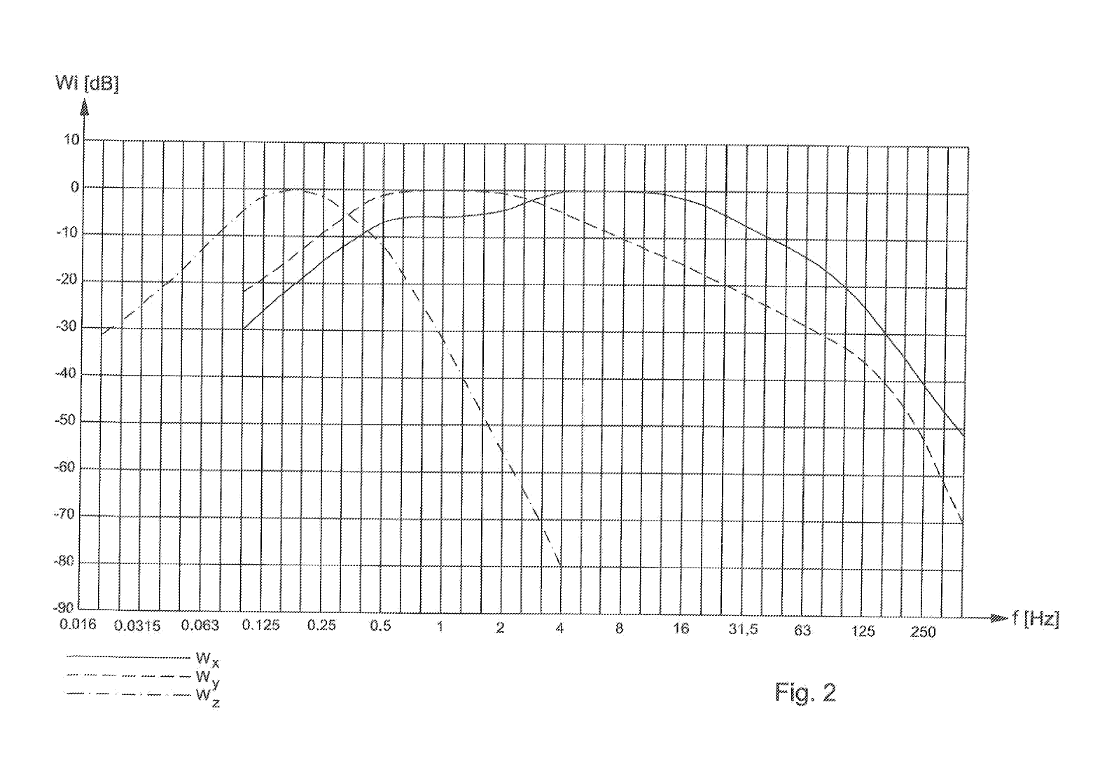

The characteristic frequency spectrum and the direction of the acceleration components a′ᵢ, appearing on the driver's seat 14, has considerable influence on the health, the comfort perception, and on the fatigue behavior of the driver. Accordingly, the evaluation unit 26 carries out a filtration of the characteristic frequency spectrum of the recorded acceleration components a′ᵢ in the sense of a weighting of physiologically relevant frequency ranges. To this end, the acceleration components a′ᵢ are multiplied with direction-dependent weighting functions Wᵢ. Their course is shown as an example in FIG. 2. In this connection, reference is made also, in particular, to the content of the publication of the International Organization for Standardization “ISO 2631-1, Mechanical Vibration and Shock—Evaluation of Human Exposure to Whole-body Vibration, Part 1: General Requirements, Second Edition 1997-05-01.”

The acceleration components Wᵢ*a′ᵢ, frequency-evaluated by the evaluation unit 26 in such a way, form the basis for the calculation of the relevant effective values a_{wi},

$${a}_{wi} = \sqrt{\frac{1}{T} \int {( {W}_{i} \cdot {a}_{i}^{′} )}^{2} \cdot d t} ,$$

and a daily vibration dosage A(T₀), standardized to a prespecified daily work time T₀, whose determination will be explained in more detail below. A typical daily work time of 8 hours is hereby set for T₀—that is A(T₀)=A(8). Since the driver, as a rule, uses different vehicles in this time period and thus is exposed to more than only one vibration source, a separate daily vibration dosage A(8) is to be determined for each of the vehicles:

$${A}_{x}^{n} ( 8 ) = 1.4 \cdot {a}_{wx} \sqrt{\frac{T}{8}}$$

$${A}_{y}^{n} ( 8 ) = 1.4 \cdot {a}_{wy} \sqrt{\frac{T}{8}}$$

$${A}_{z}^{n} ( 8 ) = {a}_{wz} \sqrt{\frac{T}{8}}$$

wherein T represents the time period of the daily vibration exposure relative to the nth vehicle (n∈IN). The daily vibration dosage A(8) is then given as a maximum of the quadratic sum of the separate daily vibration dosages Aᵢⁿ (8):

$${A}_{i} ( 8 ) = \sqrt{{\sum }_{n} {{A}_{i}^{n} ( 8 )}^{2}} ,$$

that is, A(8)=max [Aₓ(8), A_{y}(8), A_{z}(8)].

The dosage magnitude reflected in this case by the daily vibration dosage A(8) is subsequently transferred to a storage unit 32 by the evaluation unit 26, wherein the dosage magnitude is filed in the storage unit 32 in the form of an appropriate dosage entry.

Since the daily vibration dosage A(8) increases with time and intensity of the vibration exposure, the dosage entry filed in the storage unit 32 is brought up to date by the evaluation unit 26, at regular intervals, by a recalculation of the dosage magnitude. The up-to-date daily vibration dosage A(8) and its maintenance, in conformity with the guideline, are hereby checked, at any time, by the reading of the storage unit 32 by the driver or by the drivers' employer.

In addition to the daily vibration dosage A(8), the dosage entry comprises a time stamp, correlated with the daily vibration dosage A(8). The time stamp comprises a date indication, which makes possible an evaluation of the time course of the vibration exposure even over a longer period of time.

The storage unit 32 is a semiconductor storage unit, more accurately stated, a rewritable storage card 34, such as a flash storage unit. The storage card 34 may be a Secure Digital Memory Card (SD). Alternatively, it can also be a Multimedia Card (MMC) or Memory Stick (MS), wherein the latter can be connected with the evaluation unit 26 via a Universal Serial Bus (USB).

The storage card 34 communicates, via a reversible interface 36, to produce a detachable data exchange connection with the evaluation unit 26. The reversible interface 36 is an electric plug connection 38. This permits it to remove the storage card 34 from the system 10 and to exchange it for another storage card. In other words, it is possible to assign each driver his own storage card for the recording and monitoring of his individual vibration dosage.

In order to be able to assign the storage card 34 to a specific driver, it is equipped with a suitable identification feature. The identification feature is a PIN code, which before driving, is to be entered via a control panel 40, connected with the evaluation unit 26. The control panel 40 is placed in the area of the armrest 28, designed as a control console, and communicates with the evaluation unit 26, via the CAN data bus 24.

Moreover, the evaluation unit 26 is connected with a vehicle-affixed display 42 for displaying the calculated dosage magnitude. The display 42 is a graphics-capable display unit which can display information graphically as diagrams, in addition to a numerical display of the daily vibration dosage A(8).

In order to alert the driver to the reaching of a critical daily vibration dosage A(8), the evaluation unit 26 causes an warning device 44 to generate an acoustic and/or optical warning signal, if the calculated dosage magnitude is greater than a threshold value pre-specified for a daily vibration dosage A(8). The optical warning signals may be easily understandable pictogram-like and/or variously colored graphic warning representations. In addition, a vehicle-affixed signal transmitter 46 for generating acoustic warning signals is provided.

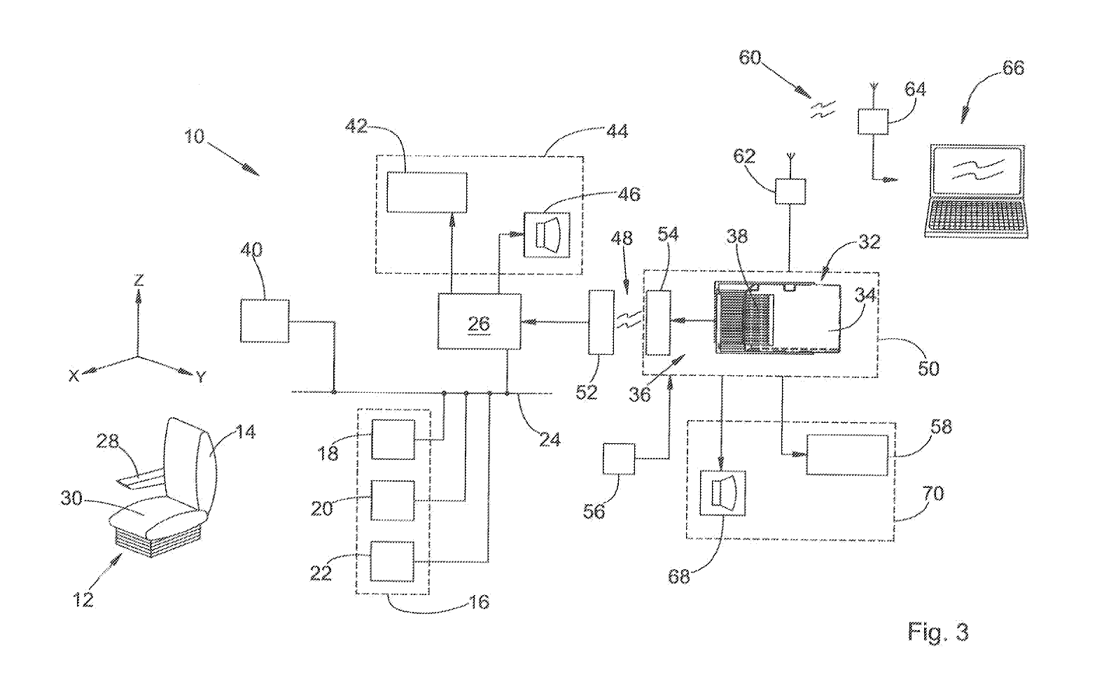

FIG. 3 shows a second embodiment of a system for determining a vibration dosage, wherein the system 10 differs from the first embodiment to the effect that another reversible interface 48 is provided. In this case, it is a wireless data transmission path, such as a Bluetooth or infrared interface.

The storage card 34 in this case is accommodated in a mobile terminal 50, which can be carried by the driver, in particular, a mobile telephone, a handheld computer, a laptop, or the like. The mobile terminal 50 is connected for data exchange with the evaluation unit 26, via a corresponding transceiver 52 and 54. Its setup takes place either automatically as soon as the mobile terminal 50 is in the reception area of the wireless data transmission path, or by initialization by the driver.

The PIN code for identification of the driver can be entered when driving begins, optionally via the vehicle-affixed control panel 40 or a keypad 56 correlated with the mobile terminal 50.

Differing from the first embodiment example, the display of the calculated dosage magnitude takes place by wireless transmission via the reversible interface 48 on the mobile terminal 50, equipped with a corresponding display 58. In addition, a wireless transmission of the dosage magnitude to be visualized via a GSM or UMTS network 60 is provided by means of an appropriate transceiver 62 and 64 at a control center 66. The display 58, correlated with the mobile terminal 50, is, at the same time, used to give out optical warning signals, referring to a reaching of a critical daily vibration dosage A(8). A signal transmitter 68, correlated with the mobile terminal 50, is also used for generating appropriate acoustic warning signals. The display 58 and the signal transmitter 68 are a joint component of an warning device 70, comprised by the mobile terminal 50.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

I claim:

1. A system for determining a vibration dosage in a vehicle, the system comprising:
a component which is movably supported on the vehicle;
a sensor for sensing movement of the component; and
an evaluation unit, the evaluation unit calculating a dosage magnitude representing a vibration dosage based on the sensed movement, wherein the evaluation unit transmits the calculated dosage magnitude to a storage unit, wherein the dosage magnitude is filed in the storage unit in the form of an appropriate dosage entry.

2. The system of claim 1, wherein:
the dosage entry comprises a daily vibration dosage, standardized to a prespecified daily work time, and/or a time stamp, correlated with the daily vibration dosage.

3. The system of claim 1, wherein:
the storage unit communicates with the evaluation unit, via a reversible interface, to produce a detachable data exchange connection.

4. The system of claim 3, wherein:
the reversible interface comprises an electric plug connection.

5. The system of claim 3, wherein:
the reversible interface is a wireless data transmission path.

6. The system of claim 1, wherein:
the storage unit is a semiconductor storage unit.

7. The system of claim 1, wherein:
the storage unit is equipped with an identification feature.

8. The system of claim 1, wherein:
the evaluation unit is connected with a display which displays the calculated dosage magnitude.

9. The system of claim 1, wherein:
the evaluation unit causes a warning device to generate an acoustic and/or optical warning signal, if the calculated dosage magnitude is greater than a pre-specified threshold value for the daily exposure to be maintained.

10. The system of claim 1, wherein:
The sensor is an acceleration sensor.

11. The system of claim 1, wherein:
the evaluation unit filters a characteristic frequency spectrum of the sensed movement magnitude with a weighting of physiologically relevant frequency ranges.
